(19) United States
(12) Patent Application Publication
(10) Pub. No.: US 2005/0179422 A1
(43) Pub. Date: Aug. 18, 2005

(54) Driving voltage detecting device

(75) Inventor: Johnson Chiang, Taipei (TW)

Correspondence Address: BACON & THOMAS, PLLC, 625 SLATERS LANE, FOURTH FLOOR, ALEXANDRIA, VA, 22314, US

(73) Assignee: Worldwide International Patent & Trademark Office, Taipei (TW)

(21) Appl. No.: 10/777,058

(22) Filed: Feb. 13, 2004

(51) Int. Cl. G05F 1/40

(52) U.S. Cl. 323/281

(57) ABSTRACT

A driving voltage detecting device comprises a current controlling circuit connected with a loading in series which supplies an adjustable current and a feedback controlling circuit that generates a controlled signal to said current controlling circuit for keeping the loading current constant by comparing the feedback signal with a reference signal. Two comparators are designed to connect to said controlled signal to determine precisely if the driving voltage being too high or too low when supply a loading with a predetermined current.

### BACKGROUND OF THE INVENTION

1. Field of the Invention

The present invention relates to a detecting device, and more particularly it pertains to a driving voltage detecting device capable of determining if the driving voltage is too high or too low to supply a loading with a predetermined current.

2. Description of the Related Art

Transistor, a semi-conductor element, has played an important role in electronic system. Transistor is belonging to active element in opposition to passive electrical elements such as resistor, capacitor, and inductance.

The application of transistor is quite wide that it exits in most circuits such as filters, amplifiers, and comparators. In most application, transistor is used to replace passive electrical elements such as inductance and capacitor to get high qualify factor and better performance. Besides, constant current source and stable voltage source are necessary for device and apparatus even when the loading or the supply power varies, such as a LED driving device. In most LED application, the brightness and color of LED is depending on the current flow through the LED that is being asked to be stable.

Constant current supply can be accomplished by a transistor circuit, but not in all situations. There exists a minimum driving voltage of a loading with a predetermined current. The loading current will not be stable (less then the predetermined current) when the driving voltage is lower then said minimum driving voltage. It is necessary to alarm or force the circuit to stop working in this case. It is important that said minimum driving voltage is not a constant value when the loading is various. It depends on the voltage across the loading. Similarly, there also exists a maximum driving voltage of a loading with a predetermined current. The loading current will not be stable (more then the predetermined current) when the driving voltage is higher then said maximum driving voltage.

There are many patents about driving voltage detecting device. For example, U.S. Pat. No. 6,107,985, “BACKLIGHTING CIRCUIT INCLUDING BROWNOUT DETECTION CIRCUITS RESPONSIVE TO A CURRENT THROUGH AT LEAST ONE LIGHT EMITTING DIODE AND RELATED METHODS”, FIG. 4 shows its circuit diagram. FIG. 4 is assigned to be FIG. 6 in U.S. Pat. No. 6,107,985. Transistor Q1, resistor 77, amplifier 79, and reference voltage VREF is designed to supply a constant current for Backlight Array. The constant current value is equal to VREF/resistor 77 by feedback method. The current will no longer be stable when the driving voltage is lower then the minimum voltage across the loading and the circuits in series with the loading. In this case, the current decreases and the brightness of LEDs also decrease. Besides, the voltage across the resistor 77 is less then VREF. A detecting circuit is composed of comparator 91, resistor 95, and resistor 97. When the current flow through the LEDs is the predetermined current, the output of comparator 91 is positive saturated voltage (High level). When driving voltage VBAT is not sufficient to drive LEDs under the predetermined current, the current decreases and the voltage across resistor 77 also decreases. When said across voltage is lower then VREF×resistor 97/(resistor 97+resistor 95), the output of comparator 91 will be at the low level. This patent is to determine if the brightness is enough or not by the output signal level of comparator 91. This patent also controls the amplifier 79 by said output signal level and decides to stop or keep the power supplying. FIG. 1 is the relationship of driving voltage VBAT and the output signal of comparator 91. FIG. 1 is assigned to be FIG. 7 in U.S. Pat. No. 6,107,985. According to FIG. 1, when the driving voltage VBAT decreases, the feedback controlling circuit composed of resistor 77, amplifier 79, and reference voltage VREF keeps the emitter voltage of transistor Q1 to be constant. In this case, the loading current is constant even when the driving voltage decreases. The loading current will be constant until the driving voltage is higher than or equal to the minimum voltage the loading and the circuits connected to the loading in series. When the driving voltage is lower than said minimum voltage, the loading current will not be constant any more. At the same time, the emitter voltage decreases. When the emitter voltage is higher than VREF×resistor 97/(resistor 97+resistor 95), the output of comparator 91 is at the high level. When the emitter voltage is lower than VREF×resistor 97/(resistor 97+resistor 95), the output of comparator 91 is at the low level.

The resistor 97 is necessary because that the voltage upon resistor 77 may suffer the interference of the outside noise, and the threshold voltage of comparator 91 may cause detecting circuit run abnormally. Besides, in order to be the input buffer of the comparator 91 and to reduce interference of outside noise, the voltage across resistor 97 can not be too small. Please, refer to FIG. 2. It is important to know that the voltage designed to determine the driving voltage is too low to the driving loading is lower than the minimum driving voltage which is exactly why the need of the resistor 97. Besides, the detecting accuracy will be affected by the voltage Vcomp and the voltage Vcomp is changed with the reference signal because of the ratio of resistor 95 and resistor 97 is constant. Please refer to FIG. 3, the voltage Vd2 is larger then Vd1. In generally, a low-pass filter composed of resistors and capacitors is used to filter noise. Said design is not only wasting chip space, but also slowing the response time of circuits. The delay time td is shown in FIG. 1.

In order to stable the loading current when the driving voltage increases, the resistance of the current controlling circuit will increase and the consumption power will increase with the resistance. The circuit will be destroyed if the consumption power exceeds the limit of the circuit.

### SUMMARY OF THE INVENTION

For overcoming said defects described above, an object of the present invention is to provide a Driving Voltage Detecting Device in which the limit of the driving voltage can be detected precisely and immediately.

Two comparators are designed in the present invention to connect to the controlled signal of a current controlling circuit to determine the driving voltage being too high or too low precisely when supply a loading with a predetermined current.

As soon as the feedback controlling circuit loses constant current control, the present invention will do its works. The present invention is not affected by the variation of the reference signal and the current. It is also not affected by the interference of the noise.

These and other objects, features and advantages of the present invention will become more apparent from the following description and the appended claims, taken in connection with the accompanying drawings in which preferred embodiment of the present invention are shown by way of illustrative example.

### DETAILED DESCRIPTION OF THE PREFERRED EMBODIMENT

Please refer to FIG. 5, FIG. 5 shows the circuit diagram of the present invention. The loading 10 is connected to a current controlling circuit in series. In generally, said current controlling circuit can be composed of transistors and resistors. In order to keep the current constant without changing with the loading 10 or the driving voltage VDD, a feedback controlling circuit is used in generally. A resistor R is connected to the inverting input of an amplifier 20 and a reference signal VREF is connected to the non-inverting input of said amplifier 20. A transistor Q is connected to said amplifier 20. If said transistor Q is a BJT, the base is connected to said amplifier 20. If said transistor Q is MOS, the gate is connected said amplifier 20. VCC is the supply power of said amplifier. The non-inverting input of the comparator 30 is connected to the output of said amplifier 20. The inverting input of said comparator 30 is connected to said supply power VCC and a power Vuv. The inverting input of said comparator 31 is connected to the output of said amplifier 20 and the non-inverting input of said comparator 31 is connected to a power Vov.

The current flowing through the loading is decided by the reference voltage (signal) VREF and the resistor R. When the current is larger than VREF/R, the output voltage of said amplifier 20 will decrease. It means that the driving voltage of the transistor Q decreases and the voltage across transistor Q increases. It results in decreasing the current. When the VDD is too high, the voltage across to the transistor Q also increases to high and the consumption power will also increases. The output voltage of amplifier 20 will reach its minimum value in this case and the minimum value is just higher than ground. That is to say, if the comparator 31 detecting the output voltage VER of the amplifier 20 is lower then Vov, it means that the driving voltage is too high so that the current can be keep constant or the consumption power will destroy the transistor Q. On the contrary, when the current is smaller than VREF/R, the output voltage of said amplifier 20 will increase. It means that the driving voltage of the transistor Q increases and the voltage across transistor Q decreases. It results in increasing the current. When the VDD is too low, even the voltage across to the transistor Q decreases to low and the current can be keep constant. The output voltage of amplifier 20 will reach its maximum value in this case. Said maximum value called saturation voltage depending on the internal circuit. In general, the saturation voltage is similar to the DC voltage supply VCC. To apply to all kinds of amplifiers, Vuv is used to be the difference voltage of VCC. That is to say, if the comparator 30 detecting the output voltage VER of the amplifier 20 is higher then VCC-Vuv, it means that the driving voltage is too low so that the current can be keep constant.

In conclusion, the present invention comprises a current controlling circuit connected with a loading in series which supplies an adjustable current and a feedback controlling circuit that generates a controlled signal to said current controlling circuit for keeping the loading current constant by comparing the feedback signal with a reference signal. Two comparators are designed to connect to said controlled signal to determine precisely if the driving voltage being too high or too low when supply a loading with a predetermined current.

While the present invention has been described with reference to the illustrative embodiment, this description is not intended to be construed in a limited sense. Various modifications of the illustrative embodiment of the invention, such as the different accomplished circuit for the cursor controlling circuit and feedback controlling method, will be apparent to those skilled in the art with reference to this description. It is therefore completed and that the appended claims will cover any such modifications or embodiments as fall within the true scope of the invention.

### BRIEF DESCRIPTION OF THE DRAWINGS

FIG. 1 is a relationship diagram of the driving voltage and the comparator's output signal disclosed in U.S. Pat. No. 5,936,599.

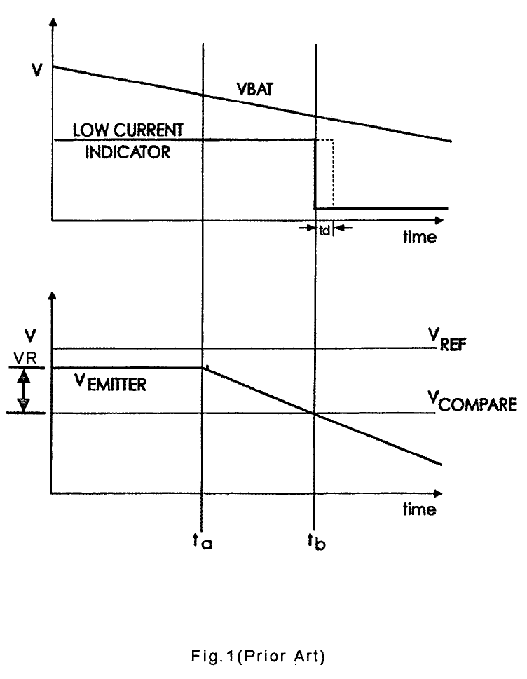

FIG. 2 is a relationship diagram of the driving voltage and the comparator's output signal with the interference of the noise according to U.S. Pat. No. 5,936,599.

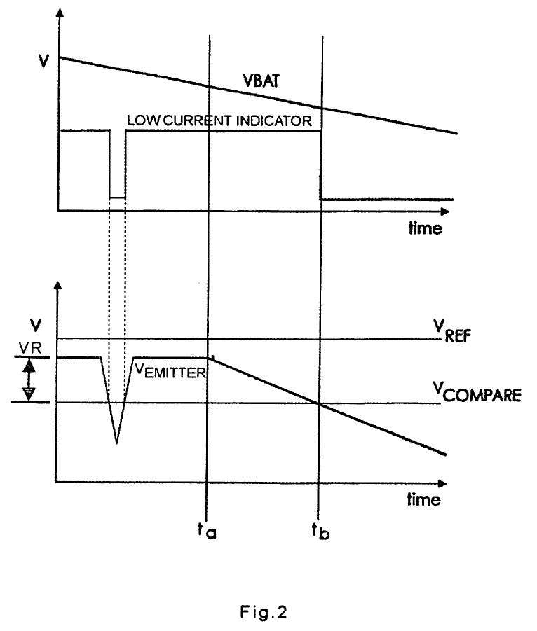

FIG. 3 is a relationship diagram of the Vref and Vcomp according to U.S. Pat. No. 5,936,599.

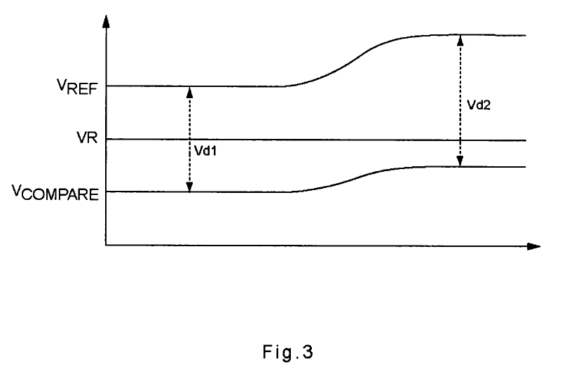

FIG. 4 is a circuit diagram disclosed in U.S. Pat. No. 5,936,599.

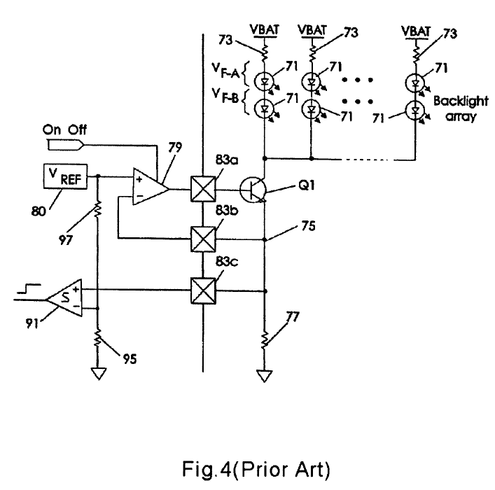

FIG. 5 is a circuit diagram of the present invention.

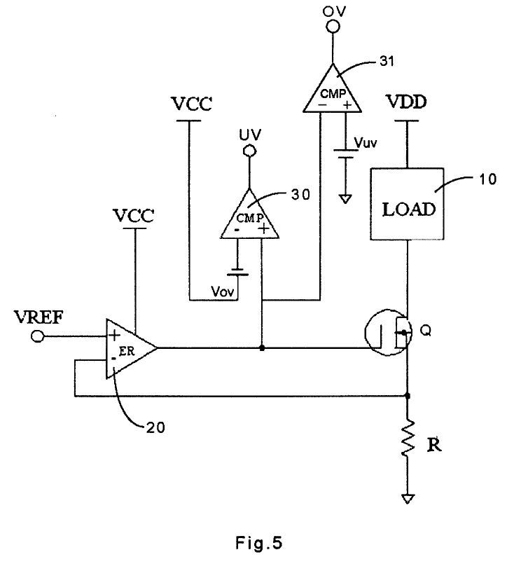

FIG. 6 is a relationship diagram of the driving voltage and comparator in the present invention.

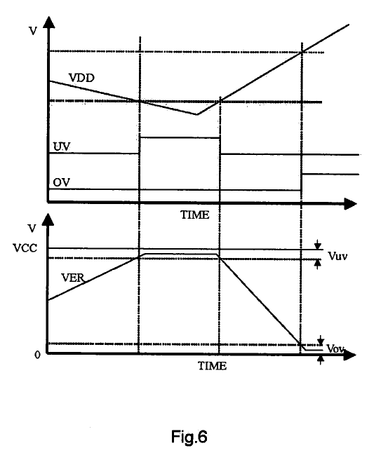

1. A driving voltage detecting device comprises:
A current controlling circuit connected with a loading in series supplies an adjustable current;
A feedback controlling circuit comparing the feedback signal with a reference signal that generates a controlled signal to said current controlling circuit for keeping the loading current constant; and
Two comparators connected to said controlled signal comparing with two reference signals separately determine the driving voltage being too high or too low to supply a loading with a predetermined current.

2. A driving voltage detecting device according to claim 1 wherein said two comparators can be reduced to one comparator to determine the driving voltage being too high to supply a loading with a predetermined current.

3. A driving voltage detecting device according to claim 1 wherein said two comparators can be reduced to one comparator to determine the driving voltage being too low to supply a loading with a predetermined current.

4. A driving voltage detecting device according to claim 1 wherein said current controlling circuit can be accomplished by transistor circuits.

5. A driving voltage detecting device according to claim 1 wherein said feedback controlling circuit can be accomplished by a resistor connected to said loading in series, and an amplifier comparing with a reference signal and the voltage across said resistor.
